(19) United States
(12) Patent Application Publication
(10) Pub. No.: US 2024/0249440 A1
(43) Pub. Date: Jul. 25, 2024

(54) COMPRESSING THREE-DIMENSIONAL MESH

(71) Applicant: Meta Platforms Technologies, LLC, Menlo Park, CA (US)

(72) Inventors: Zeyar Htet, San Mateo, CA (US); Volga Aksoy, Redwood City, CA (US); Binyamin Abramov, Rishon LeTsiyon (IL)

(21) Appl. No.: 18/417,962

(22) Filed: Jan. 19, 2024

Related U.S. Application Data
(60) Provisional application No. 63/480,966, filed on Jan. 21, 2023.

(51) Int. Cl. G06T 9/00

(52) U.S. Cl. CPC G06T 9/001

(57) ABSTRACT

Particular embodiments described herein present a technique for compressing a 3D mesh. A computing system may access a topology-coding list and a vertex list representing a 3D mesh. The vertex list may comprise X, Y, and Z coordinates for ordered vertices in the 3D mesh. The computing system may construct a predicted vertex list based on the vertex list. The computing system may generate X, Y, and Z coordinate bit streams. Each coordinate bit stream may comprise ordered coordinate values for a corresponding coordinate in the predicted vertex list. Each coordinate value in a coordinate bit stream may be represented in a corresponding number of bits. The corresponding number of bits may be stored in a memory-size list corresponding to the coordinate bit stream. The computing system may encode the topology-coding list and memory-size lists corresponding to the X, Y, and Z coordinate bit streams using Zstandard coder.

### PRIORITY

This application claims the benefit under 35 U.S.C. § 119(e) of U.S. Provisional Patent Application No. 63/480,966, filed 21 Jan. 2023, which is incorporated herein by reference.

### TECHNICAL FIELD

This disclosure generally relates to computer graphics, and in particular, related to compressing three-dimensional mesh.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Particular embodiments described herein relate to systems and methods for compressing a three-dimensional (3D) mesh. A 3D mesh is the structural build of a 3D model consisting of polygons. 3D meshes use reference points in X, Y and Z coordinates to define shapes with height, width and depth. A 3D mesh is required to describe a 3D object. The 3D mesh may allow a client device, such as an HMD, to move the 3D object in space in response to client actions. Compressing the 3D mesh may be required to save bandwidth between a server and a client. The server may typically be a cloud-based server. Unlike video compression algorithms, which have dedicated hardware on the client device, a mesh decompression does not have dedicated hardware. Thus, the mesh compression/decompression algorithm may need to be fast while achieving good compression ratios.

In particular embodiments, the computing system may generate a topology-coding list and a vertex list representing a three-dimensional (3D) mesh by performing a topology coding algorithm used by a 3D mesh compression algorithm. The 3D mesh compression algorithm may be Corto algorithm. The topology coding algorithm may process an original vertex list and a list of polygons. A polygon in the list of polygons may be represented by a number of connected vertices. In particular embodiments, a polygon may be a triangle. Each code of the topology-coding list may represent a relation of a corresponding triangle in the 3D mesh with respect to a boundary of already encoded region. The code may represent VERTEX, LEFT, RIGHT, END, BOUNDARY, DELAY, or SPLIT. The vertex list may comprise X, Y, and Z coordinates for ordered vertices in the 3D mesh. An order of the ordered vertices in the vertex list may be determined by the topology coding algorithm. In particular embodiments, a computing system may access the topology-coding list and the vertex list to compress the 3D mesh.

In particular embodiments, the computing system may construct a predicted vertex list based on the vertex list. The predicted vertex list may comprise X, Y, Z coordinates for a first vertex in the vertex list and predicted X, Y, and Z coordinates for second vertices beyond the first vertex in the vertex list. Coordinate values for X coordinate in the vertex list may be represented in N-bit integer. Coordinate values for Y coordinate in the vertex list may be represented in N-bit integer. Coordinate values for Z coordinate in the vertex list may be represented in M-bit floating point. A coordinate value in Z coordinate for a vertex indicates a depth of the vertex in the 3D mesh. Coordinate values for Z coordinate in the predicted vertex list may be converted into N-bit half float values from M-bit floating point values. Coordinate values for Z coordinate in the predicted vertex list may be treated as integer values. In particular embodiments, N may be 16, and M may be 32.

In particular embodiments, the computing system may generate X, Y, and Z coordinate bit streams. Each coordinate bit stream may comprise ordered coordinate values for a corresponding coordinate in the predicted vertex list. Each coordinate value in a coordinate bit stream may be represented in a corresponding number of bits. The corresponding number of bits may be a minimum number of bits required to represent the coordinate value. The corresponding number of bits may be stored in a memory-size list corresponding to the coordinate bit stream.

In particular embodiments, the computing system may encode the topology-coding list and X, Y, and Z memory-size lists corresponding to the X, Y, and Z coordinate bit streams using Zstandard coder. In particular embodiments, the computing system may further encode the X, Y, and Z coordinate bit streams using the Zstandard coder. In particular embodiments, the computing system may further encode additional data associated with vertices in the 3D mesh using the Zstandard coder. The additional data associated with vertices may comprise motion vectors, colors, or shades.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example of an AR/VR/MR computing environment, according to various embodiments.

FIG. 2 illustrates an example mesh compression process.

FIG. 3A illustrates an example original vertex list.

FIG. 3B illustrates an example list of polygons.

FIG. 4A illustrates an example topology-coding list.

FIG. 4B illustrates an example predicted vertex list.

FIG. 5A illustrates an example legacy bit stream generated by a correlated method used by legacy mesh compression algorithms.

FIG. 5B illustrates an example memory-size list corresponding to the legacy bit stream generated by the correlated method.

FIG. 6A illustrates an example X, Y, and Z coordinate bit streams.

FIG. 6B illustrates an example memory-size lists corresponding to the X, Y, and Z coordinate bit streams.

FIG. 7 illustrates an example method for compressing a 3D mesh, according to various embodiments.

FIG. 8 illustrates of an example AR/VR/MR computing environment, according to various embodiments.

FIG. 9 illustrates an example computer system.

### DESCRIPTION OF EXAMPLE EMBODIMENTS

Particular embodiments described herein relate to a real-time graphics rendering system configured to compressing and decompressing a 3D mesh. The embodiments may be particularly suitable for VR/AR/MR application, where computational resources may be limited and the demand for a fast and efficient mesh compression algorithm may be high. While many of the examples provided may be presented in the VR/AR/MR context, it should be appreciated that the mesh compression techniques described herein are not limited to VR/AR/MR and could be applied to any computer graphics application.

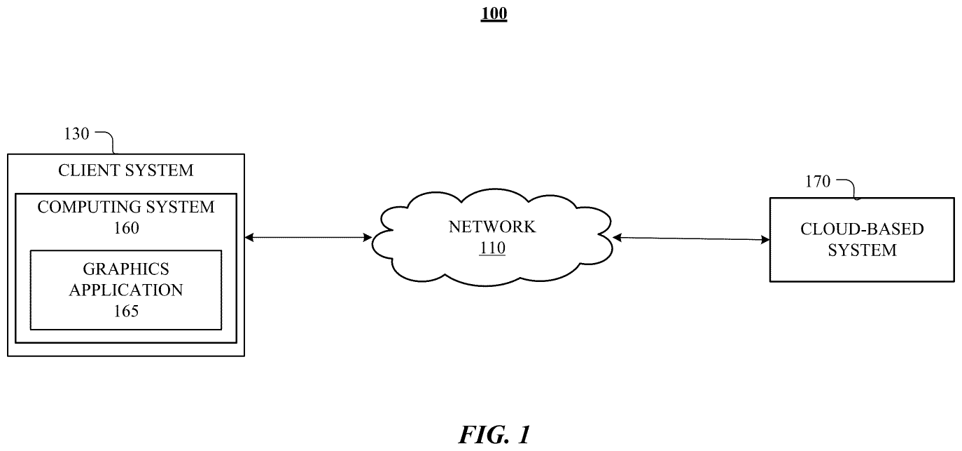

FIG. 1 illustrates an example computing environment 100, according to various embodiments. The computing environment 100 includes a client system 130 and a cloud-based system 170 (e.g., a server associated with an application 165 running on the client system 130 or a third-party system) connected to each other by a network 110. Although FIG. 1 illustrates a particular arrangement of client system 130, cloud-based system 170, and network 110, this disclosure contemplates any suitable arrangement of client system 130, cloud-based system 170, and network 110. As an example and not by way of limitation, two or more of client system 130, and cloud-based system 170 may be connected to each other directly, bypassing network 110. As another example, client system 130, and cloud-based system 170 may be physically or logically co-located with each other in whole or in part. Moreover, although FIG. 1 illustrates a particular number of client systems 130, cloud-based systems 170, and networks 110, this disclosure contemplates any suitable number of client systems 130, cloud-based systems 170, and networks 110. As an example and not by way of limitation, computing environment 100 may include multiple mobile client systems 130, cloud-based systems 170, and networks 110.

Client system 130 may be any device capable of outputting computer graphics to a user. For example, and not by way of limitation, client system 130 may be a head-mounted display, a virtual reality headset, and so forth. A client system 130 may include some or all of the functionality and components of client system 130, including for example, and not by way of limitation, one or more curved displays, one or more lenses, one or more eye-tracking systems, one or more body-worn devices, one or more headphones, and so forth. In addition, the client system 130 may receive and/or transmit signals with the cloud-based system 170. In particular, the client system 130 may output and/or receive infrared signals, optical signals, radio frequency (RFID) signals, near-field communication signals, and so forth.

Furthermore, client system 130 may include a mobile computing system 160 for rendering computer graphics. In particular, the mobile computing system 160 may include one or more processing units (e.g., a CPU, a GPU, etc.). The mobile computing system 160 may generate, store, receive, and/or send data related to computer graphics, including, for example, and not by way of limitation, visual data, audio data, tactile data, and so forth. In particular embodiments, a mobile CPU may process user input received via the client system 130 and/or the cloud-based system 170, define/modify mesh geometries, and output the mesh geometries to a mobile GPU for rendering. The mobile GPU may implement a graphics pipeline for processing vertices defining mesh geometries received from the CPU. For example, the GPU may include one or more shaders that assemble vertices into polygons, rasterize mesh geometries, pixelate mesh geometries into pixel candidates, remove occluded surfaces from pixel candidate, output pixels for display, and so forth.

In various embodiments, the graphics application 165 may have certain quality, performance, or resource limitations. For example, in various embodiments, the graphics application 165 may be configured to satisfy one or more rendering performance guidelines. For example, rendering performance guidelines may include not skipping frames and/or not generating rendering artifacts (e.g., tearing). In addition, the client system 130 may be energy constrained. For example, and not by way of limitation, the power supply of the client system 130 may be provided by a battery. Due to any of these limitations, the graphics application 165 may control the mesh geometries so that only a limited number of triangles are rendered per frame.

In particular embodiments, certain vertex-bound graphics application 165 may be configured to display VR/AR/MR illustrations. These types of illustrations may have 3D mesh representations. A 3D mesh representation may be the structural build of a 3D model consisting of polygons. 3D meshes may use reference points in X, Y and Z coordinates to define shapes with height, width and depth. A 3D mesh may be required to describe a 3D object. The 3D mesh may allow the computing system 160 to move the 3D object in space in response to user's actions. The cloud-based system 170 and the client system 130 may transfer information associated with the VR/AR/MR illustrations, including the 3D mesh representations. To save the bandwidth required for transferring information associated with the VR/AR/MR illustrations, the cloud-based system 170 or the client system 130 may compress the 3D mesh representations before the transfers. Also, the client system 130 may not have dedicated hardware for decompressing the 3D mesh while the client system 130 displays the VR/AR/MR illustrations. Thus, the mesh compression/decompression algorithm may need to be fast while achieving good compression ratios.

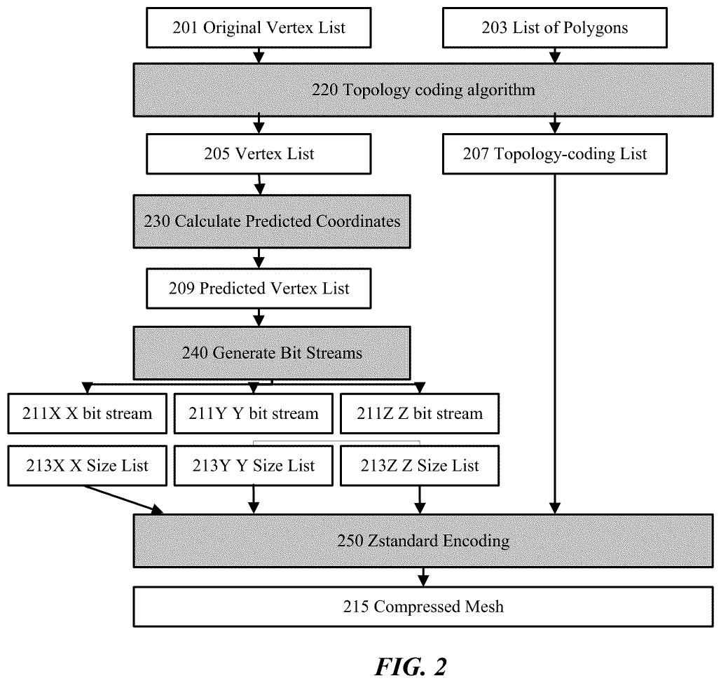

FIG. 2 illustrates an example mesh compression process. In particular embodiments, a computing system, a cloud-based system 170 or a client system 130, may generate a topology-coding list 207 and a vertex list 205 representing a 3D mesh by performing a topology coding algorithm 220 used by a 3D mesh compression algorithm. The topology coding algorithm 220 may process an original vertex list 201 and a list of polygons 203. A polygon in the list of polygons may be represented by a number of connected vertices. In particular embodiments, a polygon may be a triangle. As an example and not by way of limitation, the 3D mesh compression algorithm may be Corto algorithm. Corto is a simple, yet fast, mesh compression algorithm. The topology coding process visits one triangle at a time and maintains a list of the edges of the processed region's boundary. The processed region is always homeomorphic to a disk and is always growing, as new neighboring triangles to the region are being visited. The three edges of the first triangle are first added to the list. Then, iteratively one edge is being extracted from the list and the algorithm encodes the relation of the not-yet-visited triangle incident to the edge with respect to the boundary of the already encoded region. As another example and not by way of limitation, the 3D mesh compression algorithm may be Draco algorithm. Draco algorithm may use “Asymmetric Numeral Systems”-based entropy coding. Draco's Edgebreaker-based topology coding algorithm may yield better index compression. Although this disclosure describes generating a topology-coding list and a vertex list representing a 3D mesh in a particular manner, this disclosure contemplates generating a topology-coding list and a vertex list representing a 3D mesh in any suitable manner.

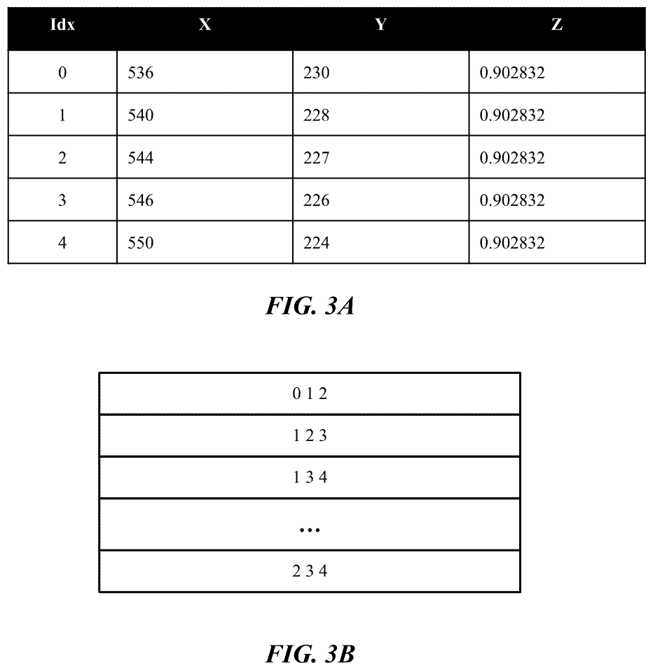

FIG. 3A illustrates an example original vertex list 201. The list comprises X, Y, and Z coordinates for ordered vertices. X, Y, and Z coordinates corresponding to a vertex represent a horizontal location, a vertical location, and a depth of the vertex, respectively. Coordinate values for X coordinate in the original vertex list 201 may be represented in N-bit integer. Coordinate values for Y coordinate in the original vertex list 201 may be represented in N-bit integer. Coordinate values for Z coordinate in the original vertex list 201 may be represented in M-bit floating point. In particular embodiments, N is 16 and M is 32. Although FIG. 3A shows only five vertices, a typical mesh may comprise much more vertices. For example, a mesh may comprise 10K vertices.

FIG. 3B illustrates an example list of polygons 203. Typical 3D mesh may utilize only triangles to represent faces in the 3D mesh. In the example illustrated in FIG. 3B, the first triangle is formed by indexed vertices 0, 1, and 2. The second triangle is formed by indexed vertices 1, 2, and 3. The third triangle is formed by indexed vertices 1, 3, and 4. The last triangle is formed by indexed vertices 2, 3, and 4. Typically, a number of triangles in a 3D mesh is larger than a number of vertices. For example, when a 3D mesh comprises 10K vertices, the 3D mesh may comprise 15K triangles.

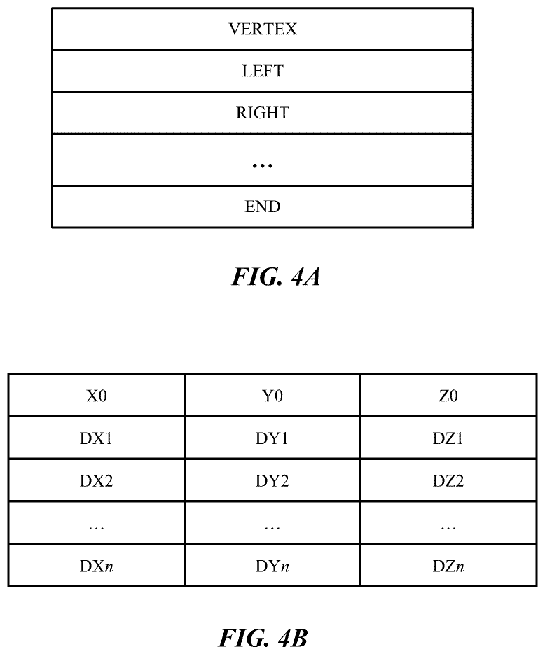

FIG. 4A illustrates an example topology-coding list 207. Each code of the topology-coding list 207 may represent a relation of a corresponding triangle in the 3D mesh with respect to a boundary of already encoded region. The topology-coding list 207 may be referred to as a “CLERS” table. The code may represent VERTEX, LEFT, RIGHT, END, BOUNDARY, DELAY, or SPLIT. The vertex list 205 may comprise X, Y, and Z coordinates for ordered vertices in the 3D mesh. An order of the ordered vertices in the vertex list 205 may be determined by the topology coding algorithm 220. The order of the ordered vertices in the vertex list 205 may be different from the order of the ordered vertices in the original vertex list 201. During the decoding process, the 3D mesh (i.e., the original vertex list 201 and the list of polygons 203) can be reconstructed based on the vertex list 205 and the topology-coding list 207.

In particular embodiments, a computing system may determine that a mesh compression is needed. The computing system may access the topology-coding list 207 and the vertex list 205 to compress the 3D mesh. In particular embodiments, the computing system may process the original vertex list 201 and the list of polygons 203 with the topology coding algorithm 220 to generate the vertex list 205 and the topology-coding list 207. Although this disclosure describes accessing the topology-coding list and the vertex list in a particular manner, this disclosure contemplates accessing the topology-coding list and the vertex list in any suitable manner.

In particular embodiments, the computing system may construct a predicted vertex list 209 based on the vertex list 205 at step 230. FIG. 4B illustrates an example predicted vertex list 209. The predicted vertex list 209 may comprise X, Y, Z coordinates for a first vertex in the vertex list 205 and predicted X, Y, and Z coordinates for second vertices beyond the first vertex in the vertex list 205. A predicted coordinate value is a difference between a corresponding coordinate value and an average of its neighbors. The predicted coordinate value may be calculated using a “Parallelogram Prediction” method, where each value may be subtracted from the average of its neighbors on a parallelogram composed of two neighboring polygons. The predicted coordinate value may result in a small number because X, Y, Z locations of adjacent points on the polygon tend to be close to each other. Coordinate values for X coordinate in the vertex list 205 may be represented in N-bit integer. Coordinate values for Y coordinate in the vertex list 205 may be represented in N-bit integer. Coordinate values for Z coordinate in the vertex list 205 may be represented in M-bit floating point. A coordinate value in Z coordinate for a vertex indicates a depth of the vertex in the 3D mesh. Coordinate values for Z coordinate in the predicted vertex list 209 may be converted into N-bit half float values from M-bit floating point values. Coordinate values for Z coordinate in the predicted vertex list 209 may be treated as integer values. In particular embodiments, N may be 16, and M may be 32. Although this disclosure describes constructing a predicted vertex list based on the vertex list in a particular manner, this disclosure contemplates constructing a predicted vertex list based on the vertex list in any suitable manner

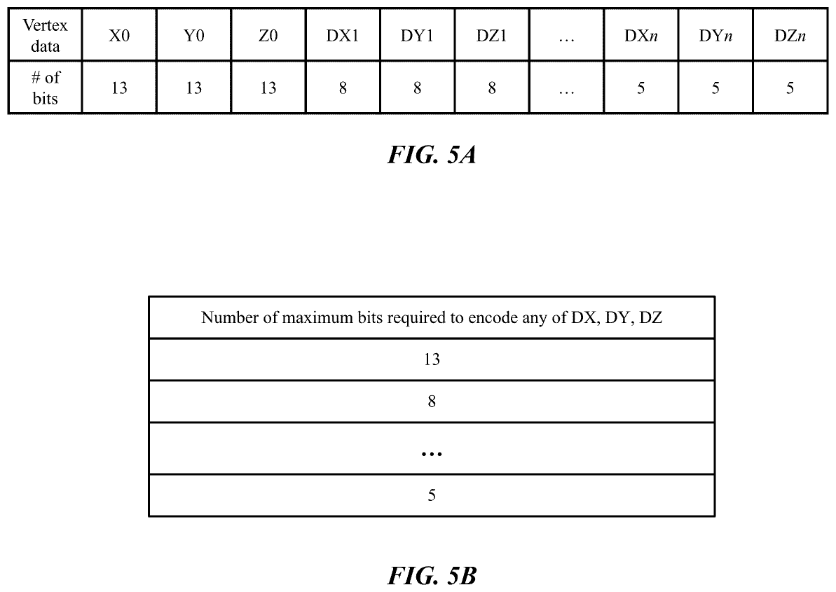

FIG. 5A illustrates an example legacy bit stream generated by a correlated method used by legacy mesh compression algorithms. The second row indicating the number of bits for each data element is shown for an illustration purpose. The bit stream comprises only a series of data elements. With the correlated method, a number of bits required to encode each triplet of vertex coordinates may be determined as a maximum number of bits for any of the coordinate values in the triplet. In the example illustrated in FIG. 5A, X0 and Y0 for the first vertex V0 may require 11 bits each. But, because coordinate value Z0 for V0 requires 13 bits to store, each of X0, Y0, and Z0 is stored in 13 bits. Predicted coordinate values DX1 and DY1 for the second vertex V1 may require 3 bits each to store. But, because predicted coordinate value DZ1 for V1 requires 8 bits to store, each of DX1, DY1, and DZ1 is stored in 8 bits. Predicted coordinate values DXn and DYn for the last vertex Vn may require 3 bits and 2 bits, respectively, to store the values. However, because predicted coordinate value DZn for Vn requires 5 bits, each of DXn, DYn, and DZn is stored in 5 bits.

FIG. 5B illustrates an example memory-size list corresponding to the legacy bit stream generated by the correlated method. Each element of the memory-size list indicates a number of bits used to store each coordinate value for a vertex. Because each of X0, Y0, and Z0 is stored in 13 bits, the first element of the example memory-size list is 13. Because each of DX1, DY1, and DZ1 is stored in 8 bits, the second element of the example memory-size list is 8. Because each of DXn, DYn, and DZn is stored in 5 bits, the last element of the example memory-size list is 5. The memory-size list illustrated in FIG. 5B may be compressed using an entropy coder. A computing system may reconstruct a predicted vertex list based on a bit stream illustrated in FIG. 5A and its corresponding memory-size list illustrated in FIG. 5B.

While the memory-size list illustrated in FIG. 5B comprises only one element per vertex, the bit stream generated by the correlated method as illustrated in FIG. 5A may waste memory space. In general, Z coordinate values may require significantly more memory space than X and Y coordinate values. Thus, memory spaces for X and Y coordinate values may be wasted. Considering that a compression ratio of a memory-size list is usually high, using separate memory-space list for each of X, Y, and Z coordinates may yield better compression output of a 3D mesh.

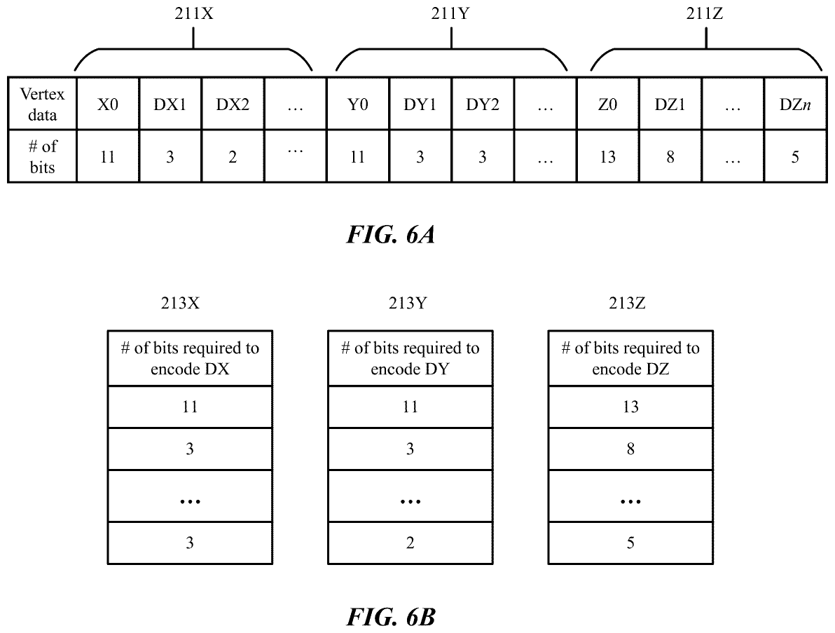

In particular embodiments, the computing system may generate X, Y, and Z coordinate bit streams at step 240. Each coordinate bit stream may comprise ordered coordinate values for a corresponding coordinate in the predicted vertex list. Each coordinate value in a coordinate bit stream may be represented in a corresponding number of bits. The corresponding number of bits may be a minimum number of bits required to represent the coordinate value. The corresponding number of bits may be stored in a memory-size list corresponding to the coordinate bit stream. FIG. 6A illustrates an example X, Y, and Z coordinate bit streams. FIG. 6B illustrates an example memory-size lists corresponding to the X, Y, and Z coordinate bit streams. As an example and not by way of limitation, illustrated in FIGS. 6A and 6B, a coordinate value X0 for the first vertex V0 is stored in 11 bits in X coordinate bit stream 211X. A predicted coordinate value DX1 for the second vertex V1 is stored in 3 bits in the X coordinate bit stream 211X. A predicted coordinate value DX2 for the third vertex V2 is stored in 2 bits in the X coordinate bit stream 211X. The number of bits used for storing each X coordinate value is recorded in a memory-size list 213X corresponding to the X coordinate bit stream. A coordinate value Y0 for the first vertex V0 is stored in 11 bits in Y coordinate bit stream 211Y. A predicted coordinate value DY1 for the second vertex V1 is stored in 3 bits in the Y coordinate bit stream 211Y. A predicted coordinate value DY2 for the third vertex V2 is stored in 3 bits in the Y coordinate bit stream 211Y. The number of bits used for storing each Y coordinate value is recorded in a memory-size list 213Y corresponding to the Y coordinate bit stream. A coordinate value Z0 for the first vertex V0 is stored in 13 bits in Z coordinate bit stream 211Z. A predicted coordinate value DZ1 for the second vertex V1 is stored in 8 bits in the Z coordinate bit stream 211Z. A predicted coordinate value DZn for the last vertex Vn is stored in 5 bits in the Z coordinate bit stream 211Z. The number of bits used for storing each Z coordinate value is recorded in a memory-size list 213Z corresponding to the Z coordinate bit stream. The order of data elements in a combined bit stream may be implementation dependent. For example, the data element may be ordered as X0, Y0, Z0, DX1, DY1, DZ1, DXn, DYn, DZn as in the example illustrated in FIG. 5A. Although this disclosure describes generating uncorrelated X, Y, and Z coordinate bit streams along with their corresponding memory-size lists in a particular manner, this disclosure contemplates generating uncorrelated X, Y, and Z coordinate bit streams along with their corresponding memory-size lists in any suitable manner

In particular embodiments, the computing system may encode the topology-coding list 207 and X, Y, and Z memory-size lists 213X, 213Y, and 213Z corresponding to the X, Y, and Z coordinate bit streams 211X, 211Y, and 211Z using Zstandard coder at step 250. The output of the encoded topology-coding list 207 and the memory-size lists 213X, 213Y, and 213Z along with the X, Y, and Z coordinate bit stream 211X, 211Y, and 211Z may result a compressed mesh 215. “Tunstall” may be a widely used entropy coder by mesh compression algorithms. Additional coders such as LZ4, HUFFMAN, and ZLIB may be used for mesh compression algorithms. LZ4 may perform better than Tunslall for the topology-coding list, but LZ4 may be worse for the memory-size lists. During the tests, Zstandard entropy coder demonstrated that the entropy codec performs better than Tunstall in both the topology-coding list and the memory-size lists. Zstandard may be configured with compression levels, where the lower levels are faster but yield worse compression. The tests demonstrated that Level 9 may be fast, with close to optimum compression ratios. In addition, Zstandard coder and decoder may be trained with a training set to create dictionaries that can be loaded at runtime (by both encoder and decoder). Although this disclosure describes encoding the topology-coding list and memory-size lists corresponding to X, Y, and Z coordinate bit streams using Zstandard coder in a particular manner, this disclosure contemplates encoding the topology-coding list and memory-size lists corresponding to X, Y, and Z coordinate bit streams using Zstandard coder in any suitable manner

In particular embodiments, the computing system may further encode the X, Y, and Z coordinate bit streams using the Zstandard coder. With the legacy compression algorithms, most bit streams have been considered non-compressible. However, as Zstandard demonstrates better compression ratio than most of the existing coders, a combined X, Y, and Z coordinate bit streams may be entropy coded. Although this disclosure describes encoding the X, Y, and Z coordinate bit streams using the Zstandard coder in a particular manner, this disclosure contemplates encoding the X, Y, and Z coordinate bit streams using the Zstandard coder in any suitable manner.

In particular embodiments, the computing system may further encode additional data associated with vertices in the 3D mesh using Zstandard coder. The additional data associated with vertices may comprise motion vectors, colors, or shades. In particular embodiments, a 3D mesh may comprise additional data associated with vertices including motion vectors, colors, or shades. Those additional data may also be encoded using Zstandard coder. Although this disclosure describes encoding additional data associated with vertices in the 3D mesh using Zstandard coder in a particular manner, this disclosure contemplates encoding additional data associated with vertices in the 3D mesh using Zstandard coder in any suitable manner

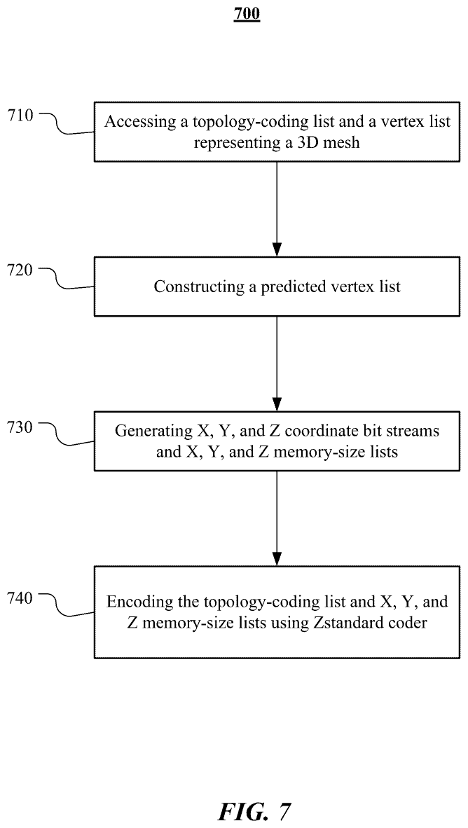

FIG. 7 illustrates an example method 700 for compressing a 3D mesh, according to various embodiments. The method 700 may begin at step 710, where a computing system may access a topology-coding list and a vertex list representing a 3D mesh. In particular embodiments, the computing system may be cloud-based system 170. In particular embodiments, the computing system may be a client system 130. In particular embodiments, the computing system may generate a topology-coding list and a vertex list representing a three-dimensional (3D) mesh by performing a topology coding algorithm used by a 3D mesh compression algorithm. The topology coding algorithm may process an original vertex list and a list of polygons. A polygon in the list of polygons may be represented by a number of connected vertices. In particular embodiments, a polygon may be a triangle. Each code of the topology-coding list may represent a relation of a corresponding triangle in the 3D mesh with respect to a boundary of already encoded region. The code may represent VERTEX, LEFT, RIGHT, END, BOUNDARY, DELAY, or SPLIT. The vertex list may comprise X, Y, and Z coordinates for ordered vertices in the 3D mesh. An order of the ordered vertices in the vertex list may be determined by the topology coding algorithm.

At step 720, the computing system may construct a predicted vertex list based on the vertex list. The predicted vertex list may comprise X, Y, Z coordinates for a first vertex in the vertex list and predicted X, Y, and Z coordinates for second vertices beyond the first vertex in the vertex list. A predicted coordinate value is a difference between a corresponding coordinate value and an average of its neighbors. The predicted coordinate value may be calculated using a “Parallelogram Prediction” method, where each value may be subtracted from the average of its neighbors on a parallelogram composed of two neighboring polygons. Coordinate values for X coordinate in the vertex list may be represented in N-bit integer. Coordinate values for Y coordinate in the vertex list may be represented in N-bit integer. Coordinate values for Z coordinate in the vertex list may be represented in M-bit floating point. A coordinate value in Z coordinate for a vertex indicates a depth of the vertex in the 3D mesh. Coordinate values for Z coordinate in the predicted vertex list may be converted into N-bit half float values from M-bit floating point values. Coordinate values for Z coordinate in the predicted vertex list may be treated as integer values. In particular embodiments, N may be 16, and M may be 32.

At step 730, the computing system may generate X, Y, and Z coordinate bit streams and their corresponding memory-size lists. Each coordinate bit stream may comprise ordered coordinate values for a corresponding coordinate in the predicted vertex list. Each coordinate value in a coordinate bit stream may be represented in a corresponding number of bits. The corresponding number of bits may be a minimum number of bits required to represent the coordinate value. The corresponding number of bits may be stored in a memory-size list corresponding to the coordinate bit stream.

At step 740, the computing system may encode the topology-coding list and X, Y, and Z memory-size lists corresponding to the X, Y, and Z coordinate bit streams using Zstandard coder.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for compressing a 3D mesh including the particular steps of the method of FIG. 7, this disclosure contemplates any suitable method for compressing a 3D mesh including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

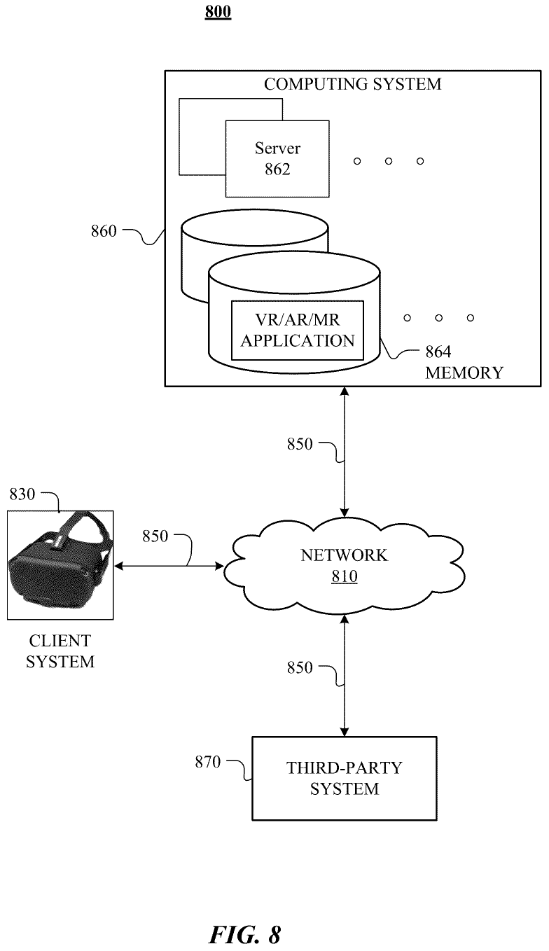

FIG. 8 illustrates an example augmented reality (AR) computing environment 800, according to various embodiments. VR/AR/MR computing environment 800 includes a client system 830, a computing system 860, and a third-party system 870 connected to each other by a network 810. Although FIG. 8 illustrates a particular arrangement of client system 830, computing system 860, third-party system 870, and network 810, this disclosure contemplates any suitable arrangement of client system 830, computing system 860, third-party system 870, and network 810. As an example and not by way of limitation, two or more of client system 830, computing system 860, and third-party system 870 may be connected to each other directly, bypassing network 810. As another example, two or more of client system 830, computing system 860, and third-party system 870 may be physically or logically co-located with each other in whole or in part. Moreover, although FIG. 8 illustrates a particular number of client systems 830, computing systems 860, third-party systems 870, and networks 810, this disclosure contemplates any suitable number of client systems 830, computing systems 860, third-party systems 870, and networks 810. As an example and not by way of limitation, VR/AR/MR computing environment 800 may include multiple client systems 830, computing systems 860, third-party systems 870, and networks 810.

In various embodiments, computing system 860 may generate, store, receive, and send data related to generating a VR/AR/MR environment, including, for example, and without limitation, visual data, audio data, tactile data, and so forth. In various embodiments, computing system 860 may include one or more of a personal computer, a server computer, a desktop computer, and so forth. Computing system 860 may be accessed by the other components of VR/AR/MR computing environment 800 either directly or via network 810. For example, client system 830 may receive one or more frames from the computing system 860 for display to a user.

In various embodiments, the computing system 860 may include a server 862 and/or a memory 864. The server 862 may execute the core tasks of the computing system 860. For example, the server 862 may include one or more processors, microprocessors, application-specific integrated circuits, and so forth that access data from memory 864, store data in memory 864 and process data. In addition, the server 862 may include a central processing unit (CPU) and a graphics processing unit (GPU). In various embodiments, the CPU may execute the core functionality of the server, including, for example, and not by way of limitation, processing user input, defining mesh geometries, modifying mesh geometries, outputting modified mesh geometries to a GPU for rendering, and so forth. The GPU may be configured to render mesh geometries received from the CPU. In particular, the GPU may implement a graphics pipeline for processing vertices defining mesh geometries received from the CPU. For example, the GPU may include one or more shaders that assemble vertices into polygons, rasterize mesh geometries, pixelate mesh geometries in pixel candidates, remove occluded surfaces from pixel candidates, output pixels for display, and so forth. In various embodiments, the GPU may be configured to render large numbers of triangles per frame. For example, the GPU may be configured to render of order 10⁶ or more triangles per frame. In addition, the GPU may satisfy stringent rendering performance guidelines, including, for example and not by way of limitation, rendering each frame of a VR/AR/MR illustration completely, without skipping frames and without generating rendering artifacts (e.g., tearing between frames). In various embodiments, the memory 864 may store frames, mesh geometries, and so forth, corresponding to a VR/AR/MR illustration (e.g., an animation) being rendered. For example, memory 864 may store one or more control points that define a mesh geometry. Additionally, or alternatively, memory 864 may store one or more mesh elements (e.g., vertices, edges, etc.) that define a mesh geometry.

In particular embodiments, third-party system 870 may be any type of system capable of interacting with client system 830 and/or computing system 860. For example, and not by way of limitation, third-party system 870 may be one or more of a wall-mounted speaker system, a mobile sensor system, a haptic actuator, an infrared sensor, and so forth. Third-party system 870 may be accessed by the other components of VR/AR/MR computing environment 800 either directly or via network 810. In particular embodiments, one or more client systems 830 may access, send data to, and receive data from computing system 860 or third-party system 870. The client system 830 may access computing system 860 or third-party system 870 directly, via network 810, or via a third-party system. As an example and not by way of limitation, client system 830 may access third-party system 870 via computing system 860.

This disclosure contemplates any suitable network 810. As an example and not by way of limitation, one or more portions of network 810 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 810 may include one or more networks 810.

Links 850 may connect client system 830, computing system 860, and third-party system 870 to communication network 810 or to each other. This disclosure contemplates any suitable links 850. In particular embodiments, one or more links 850 include one or more wirelines (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 850 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 850, or a combination of two or more such links 850. Links 850 need not necessarily be the same throughout VR/AR/MR computing environment 800. One or more first links 850 may differ in one or more respects from one or more second links 850.

The client system 830 may be any type of system capable of receiving input and/or delivering output, such as, for example and not by way of limitation, a head-mounted display, an augmented/virtual reality system, and so forth. In some embodiments, the client system 830 may receive information from one or more of computing system 860 and/or third-party system 870. For example, client system 830 may include one or more displays for outputting a rendered frame. In operation, client system 830 may receive pixel information corresponding to a rendered frame from the computing system 860. The pixel information may define one or more parameters (e.g., a color) for one or more pixels of a display included in the client system 830. Client system 830 may utilize the received pixel information to project the frame to a user via a display. In some embodiments, the client system may itself be configured to perform rendering tasks, such as generating mesh geometries for virtual objects based on their assigned simplification levels and rendering images using those mesh geometries.

In addition, client system 830 may include other devices that may deliver various types of visual, audio, and sensory information to a user. For example, and not by way of limitation, client system 830 may include one or more headphones that delivers audio signals to a user. In various embodiments, the computing system 860 may encode an audio signal and transmit the encoded audio signal to the client system 830 for output to a user. The client system 830 may decode the audio signal and further output the audio signal to the user via a speaker (e.g., a set of headphones). In some embodiments, the audio signal may be designed to match a visual characteristic of a VR/AR/MR illustration that s visually displayed to a user via a display. For example, and not by way of limitation, the audio signal may be modified by one or more head-related transfer functions in order to alter a user-perceived position of a source of an audio signal. In particular, the user-perceived audio source position may be altered to match a visually-displayed position of the source on a display of the client system 830.

Additionally, or alternatively, the client system 830 may output information to one or more of the computing system 860 and/or the third-party system 870. For example, the client system 830 may include one or more devices that transmit information to the computing system 860 and/or the third-party system 870. Devices may include, for example, and not by way of limitation, hand-held devices (e.g., a joystick), head-mounted devices (e.g., a head-mounted display), body-worn devices, and so forth. In various embodiments, the devices may output one or more types of signals, including, for example and not by way of limitation, infrared signals, optical signals, radio frequency (RFID) signals, near-field communication signals, and so forth, that are detected by the computing system 860 and/or the third-party system 870.

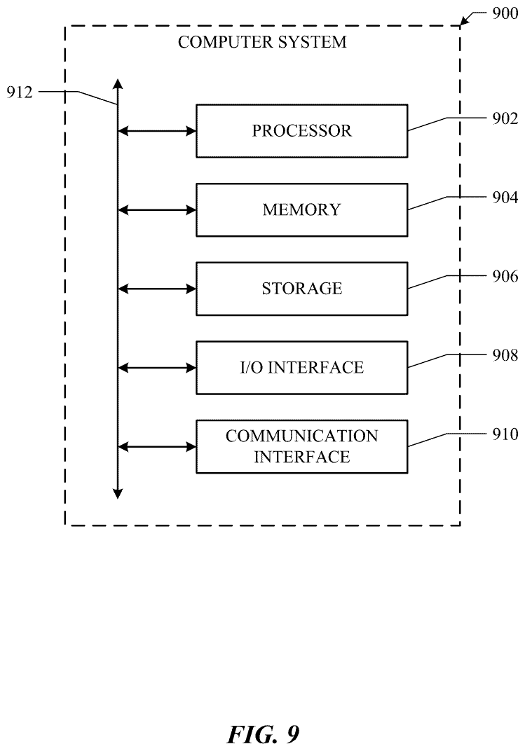

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates a particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising, by a computing system:
accessing a topology-coding list and a vertex list representing a three-dimensional (3D) mesh, wherein the vertex list comprises X, Y, and Z coordinates for ordered vertices in the 3D mesh;
constructing, based on the vertex list, a predicted vertex list comprising X, Y, Z coordinates for a first vertex in the vertex list and predicted X, Y, and Z coordinates for second vertices beyond the first vertex in the vertex list;
generating X, Y, and Z coordinate bit streams, wherein each coordinate bit stream comprises ordered coordinate values for a corresponding coordinate in the predicted vertex list, wherein each coordinate value in a coordinate bit stream is represented in a corresponding number of bits, wherein the corresponding number of bits is stored in a memory-size list corresponding to the coordinate bit stream; and
encoding, using Zstandard coder, the topology-coding list and X, Y, and Z memory-size lists corresponding to the X, Y, and Z coordinate bit streams.

2. The method of claim 1, wherein each code of the topology-coding list represents a relation of a corresponding triangle in the 3D mesh with respect to a boundary of already encoded region.

3. The method of claim 2, wherein the code represents VERTEX, LEFT, RIGHT, END, BOUNDARY, DELAY, or SPLIT.

4. The method of claim 1, wherein the topology-coding list and the vertex list are generated by a topology coding algorithm used by a 3D mesh compression algorithm.

5. The method of claim 4, wherein the topology coding algorithm processes an original vertex list and a list of polygons, wherein a polygon in the list of polygons is represented by a number of connected vertices.

6. The method of claim 4, wherein an order of the ordered vertices in the vertex list is determined by the topology coding algorithm.

7. The method of claim 4, wherein the 3D mesh compression algorithm is Corto algorithm.

8. The method of claim 1, wherein coordinate values for X coordinate in the vertex list are represented in N-bit integer, wherein coordinate values for Y coordinate in the vertex list are represented in N-bit integer, and wherein coordinate values for Z coordinate in the vertex list are represented in M-bit floating point.

9. The method of claim 8, wherein a coordinate value in Z coordinate for a vertex indicates a depth of the vertex in the 3D mesh.

10. The method of claim 8, wherein the coordinate values for Z coordinate in the predicted vertex list are converted into N-bit integer values from M-bit floating point values.

11. The method of claim 10, wherein N is 16, and wherein M is 32.

12. The method of claim 1, wherein the corresponding number of bits is a minimum number of bits required to represent the coordinate value.

13. The method of claim 1, further comprising:
encoding the X, Y, and Z coordinate bit streams using the Zstandard coder.

14. The method of claim 1, further comprising:
encoding additional data associated with vertices in the 3D mesh using the Zstandard coder.

15. The method of claim 14, wherein the additional data associated with vertices in the 3D mesh comprises motion vectors, colors, or shades.

16. A system comprising: one or more processors and one or more computer-readable non-transitory storage media coupled to one or more of the processors, the one or more computer-readable non-transitory storage media comprising instructions operable when executed by one or more of the processors to cause the system to:
access a topology-coding list and a vertex list representing a three-dimensional (3D) mesh, wherein the vertex list comprises X, Y, and Z coordinates for ordered vertices in the 3D mesh;
construct, based on the vertex list, a predicted vertex list comprising X, Y, Z coordinates for a first vertex in the vertex list and predicted X, Y, and Z coordinates for second vertices beyond the first vertex in the vertex list;
generate X, Y, and Z coordinate bit streams, wherein each coordinate bit stream comprises ordered coordinate values for a corresponding coordinate in the predicted vertex list, wherein each coordinate value in a coordinate bit stream is represented in a corresponding number of bits, wherein the corresponding number of bits is stored in a memory-size list corresponding to the coordinate bit stream; and
encode, using Zstandard coder, the topology-coding list and X, Y, and Z memory-size lists corresponding to the X, Y, and Z coordinate bit streams.

17. The system of claim 16, wherein each code of the topology-coding list represents a relation of a corresponding triangle in the 3D mesh with respect to a boundary of already encoded region.

18. The system of claim 17, wherein the code represents VERTEX, LEFT, RIGHT, END, BOUNDARY, DELAY, or SPLIT.

19. One or more computer-readable non-transitory storage media embodying software that is operable when executed to cause one or more processors to:
access a topology-coding list and a vertex list representing a three-dimensional (3D) mesh, wherein the vertex list comprises X, Y, and Z coordinates for ordered vertices in the 3D mesh;
construct, based on the vertex list, a predicted vertex list comprising X, Y, Z coordinates for a first vertex in the vertex list and predicted X, Y, and Z coordinates for second vertices beyond the first vertex in the vertex list;
generate X, Y, and Z coordinate bit streams, wherein each coordinate bit stream comprises ordered coordinate values for a corresponding coordinate in the predicted vertex list, wherein each coordinate value in a coordinate bit stream is represented in a corresponding number of bits, wherein the corresponding number of bits is stored in a memory-size list corresponding to the coordinate bit stream; and
encode, using Zstandard coder, the topology-coding list and X, Y, and Z memory-size lists corresponding to the X, Y, and Z coordinate bit streams.

20. The media of claim 19, wherein each code of the topology-coding list represents a relation of a corresponding triangle in the 3D mesh with respect to a boundary of already encoded region.
